(19) United States
(12) Patent Application Publication
(10) Pub. No.: US 2026/0057063 A1
(43) Pub. Date: Feb. 26, 2026

(54) Systems and Methods for Synchronizing Provisioning and Managing Credentials for Enterprise Machines

(71) Applicant: The PNC Financial Services Group, Inc., Pittsburgh, PA (US)

(72) Inventor: Sean SABALL, Pittsburgh, PA (US)

(21) Appl. No.: 18/981,868

(22) Filed: Dec. 16, 2024

Related U.S. Application Data
(60) Provisional application No. 63/686,952, filed on Aug. 26, 2024.

(51) Int. Cl. G06F 21/45

(52) U.S. Cl. CPC G06F 21/45

(57) ABSTRACT

Systems and methods are provided enforcing compliance with security controls. A request is received to implement an application that is associated with resources to be protected by credentials. A type associated with application is determined. A credential storage protocol is selected based on the determined type. A credential storage location is provisioned from a first of a plurality of types of credential storage repositories of different types based on the determined protocol. A first credential is stored in the provisioned storage location, and the first credential is provided to the application to enable the application to access the resources protected by the credentials.

### CROSS-REFERENCE TO RELATED APPLICATIONS

This application claims priority to U.S. Provisional Application No. 63/686,952, filed Aug. 26, 2024, the entirety of which is herein incorporated by reference.

### FIELD

This disclosure is related to data security and more particularly to monitoring resource provisioning and identity creation in a networked environment.

### BACKGROUND

As computing power continues to increase, organizations can take advantage of more and more tools for improving their performance. Those tools can provide wide arrays of functionalities from databases to store data to computing engines (including artificial intelligence-optimized multiprocessor engines) for performing analysis and critical tasks. Human users, in some instances both inside and outside of the organization, may be able to utilize these tools. In certain examples, one computing resource can utilize another computing resource (e.g., a web application (app) is able to interact with a database to access data associated with a customer for display).

Computing networks are utilized to interconnect the computing tools that an organization selects to include in its systems. Resources (e.g., servers, applications operating on servers, data repositories, network infrastructure) are provisioned (e.g. implemented on request) to facilitate implementation and connectivity of the network. Because of the sensitivity of access to an organization's data and other resources, security protocols are implemented to prevent unauthorized access. Users, and often networked resources themselves, are assigned identities and corresponding credentials that regulate their permissions for accessing resources. An identity is verified (e.g., by a username/password challenge) before access to a requested resource is granted.

### SUMMARY

Systems and methods are provided enforcing compliance with security controls. A request is received to implement an application that is associated with resources to be protected by credentials. A type associated with application is determined. A credential storage protocol is selected based on the determined type. A credential storage location is provisioned from a first of a plurality of types of credential storage repositories of different types based on the determined protocol. A first credential is stored in the provisioned storage location, and the first credential is provided to the application to enable the application to access the resources protected by the credentials.

As another example, a computer-implemented system for enforcing compliance with security key controls includes a resource management platform configured to provide a graphical user interface for receiving a request to implement an application that is associated with resources to be protected by credentials. An identity orchestration module is configured to: determine a type associated with application; and select a credential storage protocol based on the determined type. The system further includes a plurality of credential storage repositories of different types. The identity orchestration module is configured to provision a credential storage location from a first credential storage repository based on the determined protocol and store a first credential in the provisioned storage location, and the system is configured to provide the first credential to the application to enable the application to access the resources protected by the credentials.

### DESCRIPTION OF DRAWINGS

FIG. 1 is a diagram depicting an identity orchestrator interacting with a resource management platform and identity-controlled resources.

FIG. 2 is a diagram depicting example operations performed by an identity orchestrator.

FIG. 3 is a diagram depicting an example security improvement that can be provided by certain systems and methods herein.

FIG. 4 is a diagram depicting different types of secure identity repositories that may be selected from for storage of credentials.

FIG. 5 is a diagram depicting example logic for selecting a secure identity repository type and security protocol based on characteristics of a resource request.

FIG. 6 is a diagram depicting a comparison of different credential management tools described with reference to FIG. 5.

FIG. 7 is a diagram depicting an example implementation of a secrets management instance.

FIG. 8 is a diagram depicting an example of retrieval of secrets from a secrets management system during deployment of a resource.

FIG. 9 is a diagram depicting an example of retrieval of secrets from a secrets management system during runtime.

FIG. 10 is a diagram depicting example maintenance of dual credentials for an identity.

FIG. 11 is a diagram depicting access of credentials from a central credential provider.

FIG. 12 is a diagram depicting access of credentials from a credential provider.

FIG. 13 is a diagram depicting deployment of an application server credential provider.

FIG. 14 is a diagram depicting an identity orchestrator providing streamlined provisioning of an application registration based on a request.

FIG. 15 is a diagram depicting an identity orchestrator providing standardized privileged access patterns into a server build workflow.

FIG. 16 is a diagram depicting an identity orchestrator operating as an automated reconciliation tool for synchronizing data between systems.

FIG. 17 is a flow diagram depicting a method of enforcing compliance with security controls.

FIG. 18 is a diagram depicting an example implementation of an identity orchestrator.

FIGS. 19A, 19B, and 19C depict example systems for implementing the approaches described herein for implementing an identity orchestrator.

### DETAILED DESCRIPTION

As noted above, because of the sensitivity of access to an organization's data and other resources, identity-based security protocols are implemented to prevent unauthorized access. An identity (which may, for example, be associated with a human, an organization, a resource, or a software program) is verified, by a username/password challenge or other credential check, before access to a requested resource is granted. Improper identities, and identities with an improper scope can result in security vulnerabilities. For example, if an identity is assigned to a malicious entity (e.g., a malicious user, a malicious software entity), that identity can be used for improper purposes, such as unauthorized access to data or damaging/disabling systems to which access has been granted. As another example, proper identities could be misappropriated to facilitate malicious behavior. For example, a compromised password could enable a user or entity to gain unauthorized access to data or systems. Further, the failure to properly retire identities and credentials could lead to network vulnerabilities, where unretired identities/credentials having latent privileges to resources could be used to maliciously access and control those resources, often in difficult to detect manners.

Implementing resources (e.g., hardware/software resources), configuring those resources (e.g., installing software applications), managing identities having access to those resources and credentials associated with those identities, and ensuring compliance with data security policies can be a complex task. The difficulty of performing tasks (e.g., provisioning a server on which to install an internal-or external-facing application) tends to increase significantly as the complexity of the network grows. A user may need to interact with a variety of hardware and software platforms (or make requests to different support entities) to accomplish these tasks.

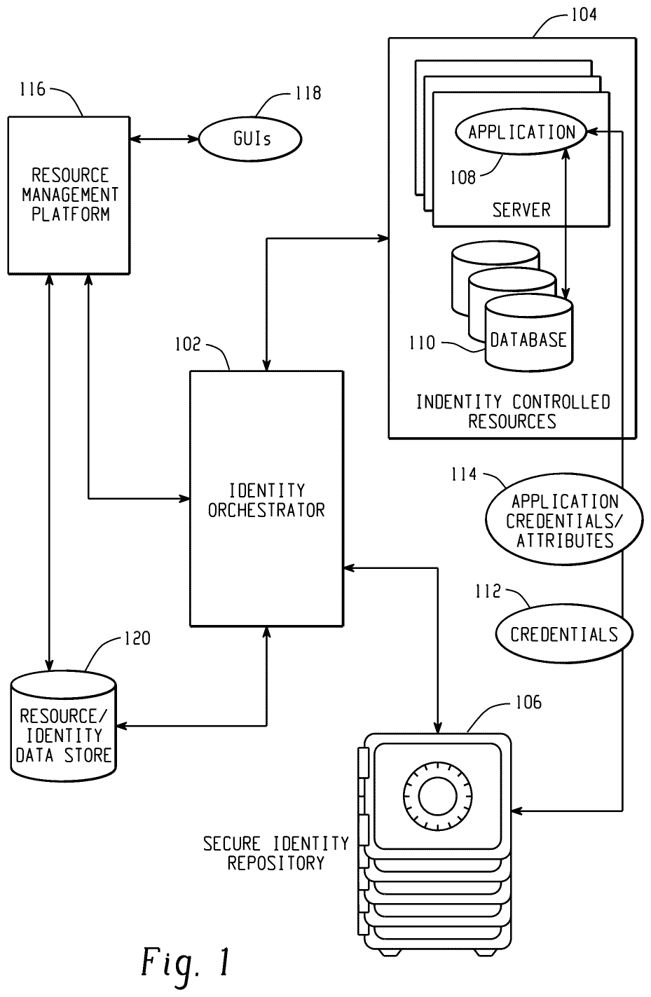

Example systems and methods described herein provide an identity orchestrator that can track data about network resources, applications, identities, and credentials such that it can automate provisioning of resources, identities, and credentials upon request, track the usage of thereof, and provide for the proper retirement of those resources, identities, and credentials, such as upon winding up of an application with which they are associated. FIG. 1 is a diagram depicting an identity orchestrator interacting with a resource management platform and identity-controlled resources. The identity orchestrator 102 provides centralized tool for providing the provisioning and implementation of desired resources, managing identities and the credentials that those identities use to access resources, and providing appropriate winding up of resources, identities, and credentials at an appropriate time.

The identity orchestrator 102 interacts with a pool of identity-controlled resources 104 to provision resources, setup and configure identities (e.g., persons, organizations, resources, software programs) to have access to those resources 104, and to manage credentials for verifying the identities before access is provided.

The orchestrator 102 of FIG. 1 further interacts with a secure identity repository 106 that provides storage and access to credentials. Credentials (e.g., a username/password combination, a security key such as a PKI public or private key) are stored in the secure identity repository 106 for safe keeping. Those credentials (e.g., at 112) may be provided upon request when certain criteria are met. For example, a software application 108 may request credentials 112 for accessing a database resource 110 within the pool of identity-controlled resources 104. The secure identity repository 106 confirms that the software application request is actually from the software application 108 that it is purporting to be and that the request is legitimate, such as by examining credentials presented by the software program or other criteria associated software program (e.g., the address from which the software program's request is originating, the time of the request, the number of requests that have been made over a recent time period) at 114. Upon confirming the software application's request, the secure identity repository 106 provides the requested credential 112 to the software application 108 to use in accessing the database 110. The secure identity repository 106 may further enforce security protocols of the system, such as requiring updating of credentials (e.g., changing passwords) upon the occurrence of an event, such as the passage of time or an indication of an actual or suspected security breach. As described further herein, in some instances, an identity orchestrator 102 and a secure identity repository 106 may implement multiple identities and/or credentials for particularly important accounts, such as those having privileged access to resources. Privileged access may include a variety of attributes including access to confidential or sensitive data, the ability to delete data from a resource, the ability to delete or deprovision resources (e.g., drop tables of a database), or the ability to edit software code associated with a resource. The secure identity repository 106 may take a variety of forms including a CyberArk implementation or a CyberArk implementation with an additional software layer to provide further desirable application capabilities.

The orchestrator 102 may further interact with a resource management platform via which requests for provisioning, managing, and retiring resources are received. The resource management platform 116 (e.g., a ServiceNow platform, a Jira platform) provides users, typically software or network system administrators, one or more graphical user interfaces 118 for requesting and managing resources 104. The user interfaces may take a variety of forms and may include a control for section of a resource from a list of resources of different types. In some instances, a request to the resource management platform 116 may come from a resource 104 itself rather than from a human requester. A request to provision a resource 104 typically includes a plurality of subrequests that are either explicitly or implicitly contained within the request. For example, a request to provision a database 110 includes a need to set up identities who are permitted to have access to the database (e.g., to modify the database, to read data from the database) and credentials to verify that only permitted identities have that access. These subrequests are typically executed by different entities, such as technical users or disparate software solutions (e.g., an identity management system, a key generation algorithm). In certain examples described herein, an identity orchestrator receives a request to provision, manage, or retire a resource 104 and oversees all explicit or implied subrequests mitigating the number of actions that are needed to be taken by the requesting party. The orchestrator 102 can thus provide end-to-end management of resources 104, identities, and credentials with minimal input requirements from the requesting entity.

In some instances, the orchestrator 102 will maintain a resource/identity data store 120 for assisting its management of resources, identities, and credentials. The resource/identity data store 120 maintains records of data that may include references to the identity-controlled resources 104 and identities that are permitted to access those identity-controlled resources 104. In embodiments, relationships between identities and resources 104 may be one-to-one, one-to-many, or many-to-one. Data store 120 is used by the orchestrator 102 to provision, set up, and manage the identity-controlled resources 104. For example, that data store 120 can be particularly useful in executing resource retirement operations. Periodically or when a command is received to retire a resource 104, an example orchestrator 102 provides a review of identities, credentials, and resources associated with that resource 104.

For example, when a first application is being retired, the orchestrator 102 queries the data store 120 to determine what identities are associated with that first application. These identities may include an identity associated with the first application itself (e.g., an identity that has permission to access data from a first data store) and identities that have access to the first application (e.g., identities associated with other applications that have permission to access the first application). The orchestrator 102 performs a review of the identities returned by the query to determine whether those identities and their corresponding credentials should be retired. For example, the identity/credentials associated with the first application being retired may be identified for retirement. If that first application identity were not retired, they could be misappropriated for use in improperly accessing the first data store, impersonating the first application despite the first application no longer existing. Other identities returned by the query may also be retired. In one example, orphaned identities that are only associated with the first application being retired might be deemed candidates for also retiring.

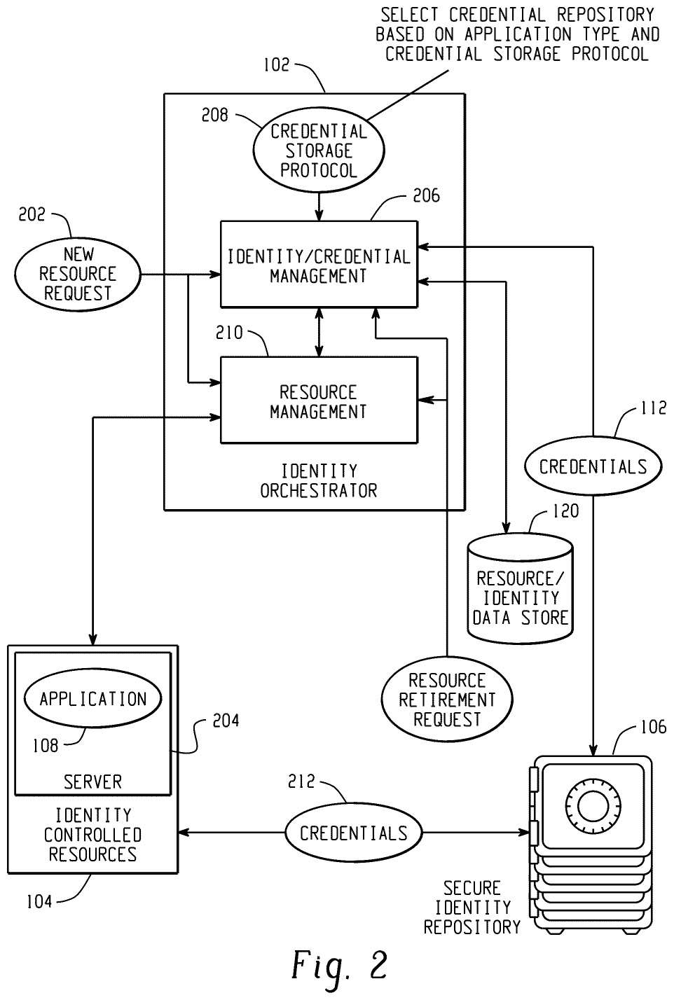

FIG. 2 is a diagram depicting example operations performed by an identity orchestrator. The identity orchestrator 102 receives a request 202 to implement a resource (e.g., an application 108 on a server 204) that is associated with resources to be protected by credentials. An identity/credential management module 206 determines a type associated with the resource request and evaluates that type relative to credential storage protocols 208. The identity/credential management module 208 selects a credential storage protocol 208 based on the resource type and provisions space on one of a plurality of credential storage repositories 106 in which to store the credentials 112. The identity/credential management module 206 stores the credentials for an identity (e.g., a new identity or an existing identity that is to have privileges relative to the requested resource) in the provisioned storage location in the credential storage repository 208.

The new resource request is further provided to a resource management module 210. The resource management module 210 interacts with a pull of identity-controlled resources 104, either directly or through an intermediary (not shown), to provision and set up the requested resource (e.g., new application 108 operating on new or existing server 204). The identity/credential management module 206 updates the resource/identity data store 120 to reflect the new resource and identities having privileges associated with that new resource. Once provisioned and set up, credentials 212 can be accessed directly by the new resource according to the security protocols associated with the credential storage repository 106 the credentials are stored in. For example, an application having appropriate privileges can use its identity to access credentials 212 associated with a database that it wishes to access in real time. The application's identity may be verified in a variety of ways. For example, the application may present credentials of its own to the repository 106 to access credentials 212. In other examples, the repository analysis characteristics associated with the application or the request from the application (e.g., a network address associated the application) to determine whether the application's request for credentials 212 is authentic and should be fulfilled.

As noted above, a system may include multiple credential storage repositories 106 of different types. Each of the different repositories 106 may have different structures and different protocols that are appropriate for different types of resources and use cases. Protocols may differ across the repositories, where a first type of credential storage repository may require maintenance (e.g., changing a password, refreshing a key) of a credential at the expiration of a first period of time or the occurrence of a security event. A second type of credential storage repository may require maintenance of credentials at the expiration of a second period of time that differs from the first period of time.

A credential repository may further have requirements regarding privileged identities, where a privileged has more different access (higher access, different access, more access) than other accounts. For example, a regular identity may have the ability to query a particular database, while a first privileged identity may have permission to delete data from the database, while a second privileged identity has permission to augment the structure of the database (e.g., to add/drop database tables). In some instances, privileged access is critical to operation of a system, such that that privileged access should remain uninterrupted. In one example, the system determines that a first credential is associated with privileged access. To enable maintenance (e.g., periodic password change at the expiration of a first expiration time period) of the first credential, the system creates and stores a second credential. The system stores the second credential in the provisioned storage location, where the second credential is associated with a second expiration period that differs from the first period of time associated with the first credential. The second credential provides a mechanism for continuing to provide privileged access to resources during maintenance of the first credential.

Credential repositories may include other differences, such as the type of credentials stored, password length/complexity requirements, and the type of validation required from an identity to release credentials to that identity.

In operation, the orchestrator 102 can set up and manage any number of identity-controlled resources 104. Having set up a first resource as described above, the orchestrator would receive a subsequent request to implement a second application that is associated with second resources. The identity/credential management module 206 determines a type associated with the second application, where the second application is determined to be of a different type than the first application. A second credential storage protocol 208 is selected based on the determined different type. A second credential storage location is provisioned in a different credential storage repository 106, and a second credential associated with an identity that is to have access to the second resource is stored in that provisioned second credential location. The resource management module 210 then interacts with the pool of identity-controlled resources 104 to provision and set up the second resource. The second resource is deployed, and the resource/identity data store 120 is updated. The second resource is then able to interact with the secure identity repositories 106 to access credentials 212.

An identity orchestrator 102 may further receive a request 214 to retire a resource. Upon receiving an indication that a resource, such as an application or service, is to be retired, the identity/credential management module 206 determines identities/credentials that are associated with the resource to be retired, such as via query to the resource/identity data store 120. The identity/credential management module determines that identities and/or credentials associated with the resource to be retired should also be retired. In this way in one example, an explicit evaluation is made of all identities and/or credentials associated with a retired resource to ensure that no orphaned identities/credentials remain.

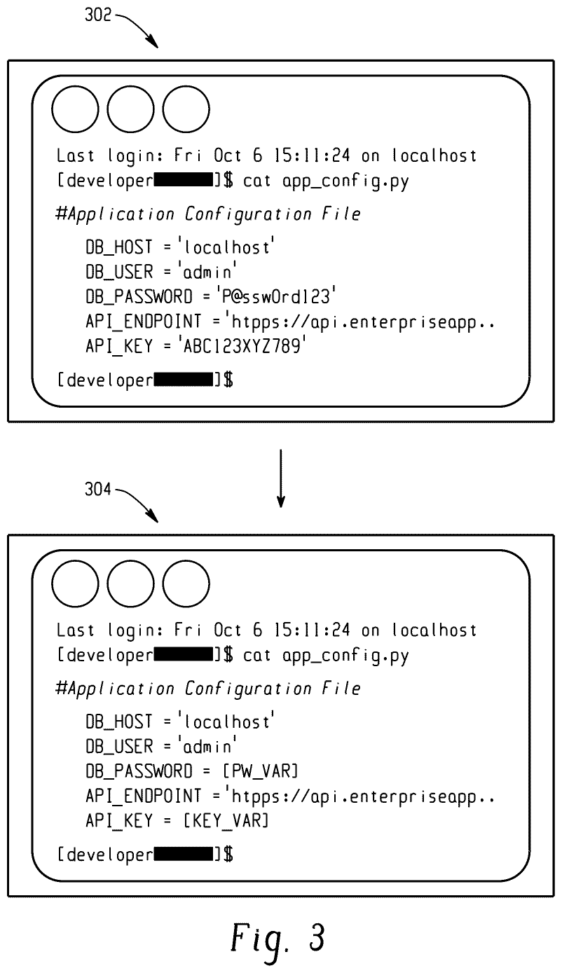

Systems and methods herein, including an identity orchestrator operating in conjunction with secure identity repositories, can be implemented in a variety of ways and provide a number of benefits. For example, systems and methods can manage identities associated with applications, such that those applications can request credentials in real time from the secure identity repositories. FIG. 3 is a diagram depicting an example security improvement that can be provided by certain systems and methods herein. As shown in FIG. 3 at 302, in instances where such real time credential acquisition is not supported, passwords (DB_Password=P@ssw0rd123) and keys (API_KEY=ABC123XYZ789) may be explicitly incorporated into software code in a manner that creates security vulnerabilities. In the example at 302, an entity accessing the depicted software code would then have access to the password and key, potentially enabling unauthorized access to the corresponding resource. Additionally, hard coding passwords and keys into software code also makes implementation of other security protocols difficult, such as password change protocols, where each time a password update is required, a corresponding edit to the software code would need to be made to keep the software functional. In contrast, systems and methods herein can provide real time queries to secure identity repositories to access passwords (PW_VAR) and keys (KEY_VAR) when the requesting application is deemed authentic via its own credentials or characteristics of its request to the secure identity repository (e.g., based on an expected address of the request, no more than n requests having been made in the past m period of time).

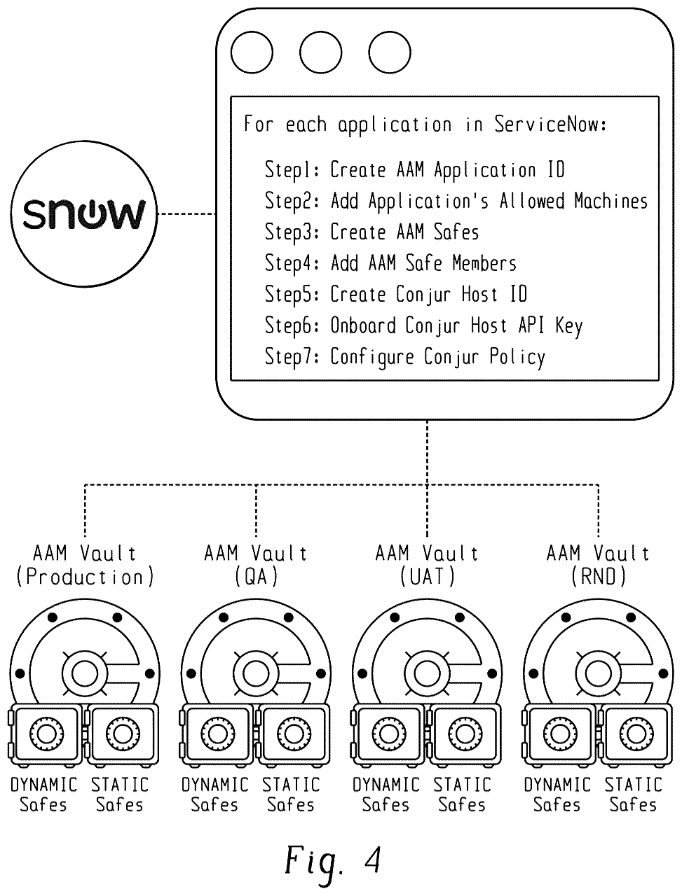

As noted above, an identity orchestrator may provision credential storage space in secure identity repositories of different types. FIG. 4 is a diagram depicting different types of secure identity repositories that may be selected from for storage of credentials. FIG. 4 provides description of certain example means for provisioning a credential storage location from a first of a number of types of credential storage repositories of different types based on a determined credential storage protocol, as disclosed further herein. For each application or other resource tracked by the system via a resource management platform, such as a resource management platform (e.g., ServiceNow), or resource/identity data store, an application identifier is assigned. Records are created or updated to indicate resources that are allowed to access that resource (i.e., the application's allowed machines). Credential storage locations in one of a plurality of secure identity repositories is provisioned based on characteristics of the resource and/or its use cases (i.e., create AAM safes), where those provisioned locations are then populated, in this instance with the assistance of a secrets management tool, such as Conjur (i.e., Add AAM Safe Members, Create Conjur Host ID, Onboard Conjur Host API Key, Configure Conjur Policy).

As illustrated in FIG. 4, in some examples, secure identity repositories may be configured as “dynamic” or “static” safes. Dynamic safes may be configured to contain secrets that are to be retrieved by dynamic applications that may run in containerized or serverless environments. In such instances, machine authentication may be facilitated by the secrets management tool (e.g., Conjur), such as using a mnemonic specific Host ID and API key. Such an implementation can enable secrets retrieval from within enterprise tools like Jenkins and OpenShift/Kubernetes. Example static safes make contain secrets retrieved by static applications that run on persistent infrastructure. There, machine authentication may be facilitated via credential providers using static attributes such as an allowed machine whitelist, a client certificate, or operating system user credentials.

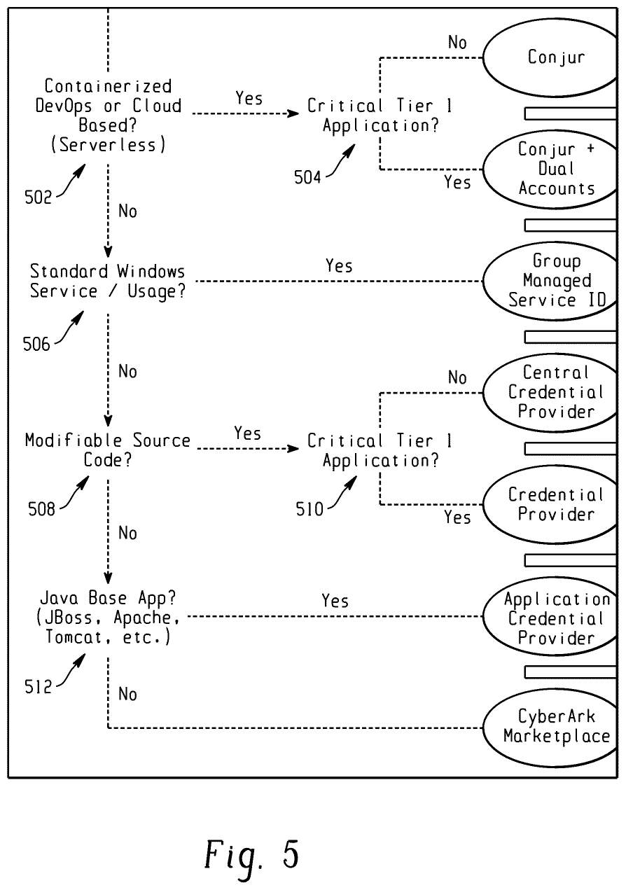

An identity/credential management module may select a secure identity repository type and other protocols based on a type of resource being provisioned and its use case. FIG. 5 is a diagram depicting example logic for selecting a secure identity repository type and security protocol based on characteristics of a resource request. FIG. 5 provides description of certain example means for determining a credential storage protocol based on an application type associated with a request to implement an application that is associated with resources to be protected by credentials. At 502, a determination is made regarding whether the request is for a containerized, DevOps, or Cloud Based serverless resource. If yes, at 504, a determination is made as to whether the requested application is a critical application. If yes, then the secrets management system is accessed for secrets management via a dynamic safe, where dual accounts are maintained for privileged access to help ensure that privileged accessed can be maintained at all times. If the application is not critical, then dual accounts may not be deemed necessary and the secrets management system is accessed without dual accounts being implemented. If the determination at 502 is no, then static safes are used for credential storage. At 506, a determination is made regarding whether the request is for standard Windows Service/usage. If so, then a group managed service ID is implemented. At 508, a determination is made as to whether the request involves modifiable source code. If so, a determination is made at 510 as to whether a critical application is involved. If yes, then a credential provider is referenced for static credential management. If not, then a credential provider may be used. At 512, a determination is made as to whether the request is associated with a Java Based App such as JBoss, Apache, or Tomcat. If so, then an application credential provider is accessed, and if not, then a CyberArk Marketplace is used.

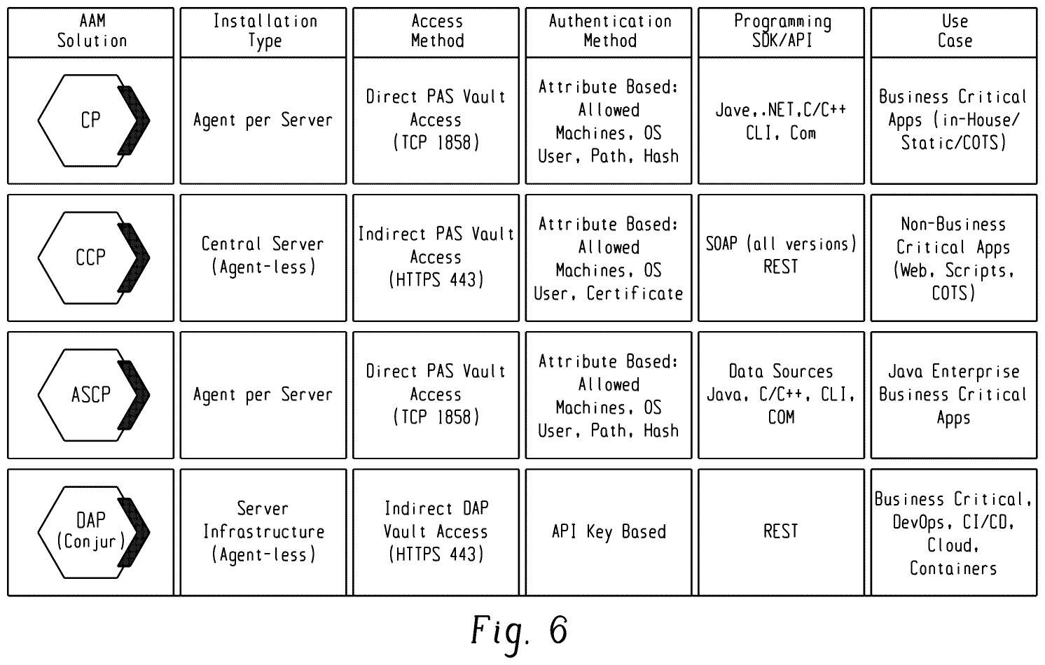

FIG. 6 is a diagram depicting a comparison of different credential management tools described with reference to FIG. 5. A credential provider may be provided for business-critical applications (e.g., in-house/Static/COTS applications). A credential provider utilizes an agent per server with direct PAS vault access (e.g., TCP 1858). A credential provider (CP) may allow attribute-based authentication of requests, such as via allowed machine whitelists, operating system user credentials, a path, or a hash. Java,. Net, C/C++, CLI, and COM may be supported. A central credential provider (CCP) may provide agentless operation for non-business critical applications, such as web applications, scripts, and COTS. The central credential provider may also use attribute-based authentication, such as via whitelists, user credentials, or certificates, with access via indirect PAS vault access (e.g., HTTPS 443). All versions of SOAP and REST may be supported. An application server credential provider (ASCP) may be used for certain Java enterprise business critical applications, where direct PAS vault access is supported (e.g., via TCP 1858). An application specific credential provider may allow attribute-based authentication of requests, such as via allowed machine whitelists, operating system user credentials, a path, or a hash. Java,. Net, C/C++, CLI, and COM may be supported. A DAP, such as Conjur, may provide server infrastructure agentless support for business critical, DevOps, CI/CD, Cloud, and Container use cases. Authentication is API key based in certain embodiments via indirect DAP vault access (e.g., HTTPS 443), with REST support.

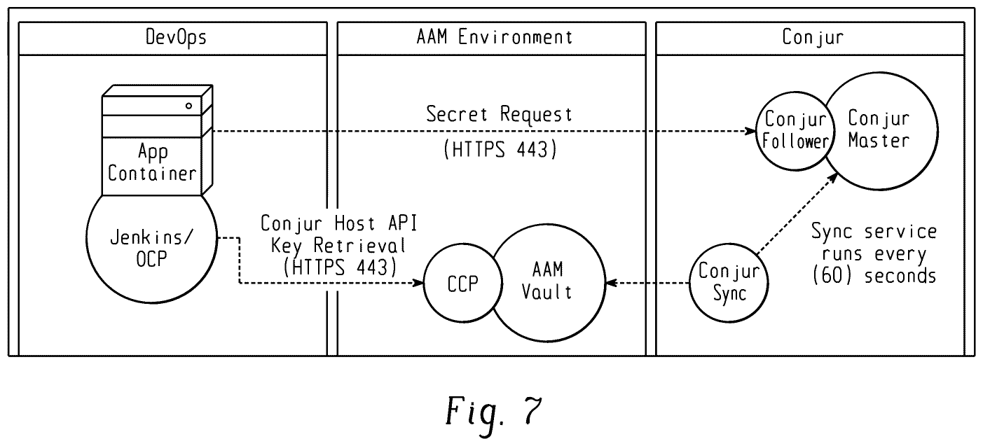

FIGS. 7-13 provide example means for providing credentials to an application from the provisioned storage location to enable the application to access the resources protected by the credentials. FIG. 7 is a diagram depicting an example implementation of a secrets management system (e.g., Conjur) instance. A secrets management tool may be used in scenarios where static attributes, like whitelisting allowed machines, is incompatible (e.g., due to the application operating in a containerized or serverless environment. In embodiments, inbound secrets retrieval requests target secrets management system followers. A vault synchronization server runs periodically (e.g., every 60 seconds), which replicates secrets stored into the secrets management system. Use cases for the secrets management system may include OpenShift, Jenkins, Azure AD, Ansible, externally hosted applications. Authentication methods for the secrets management system may include client host identifiers and API keys. Host identifiers may be automatically created and stored in static safes for applications through CMDB synchronization service.

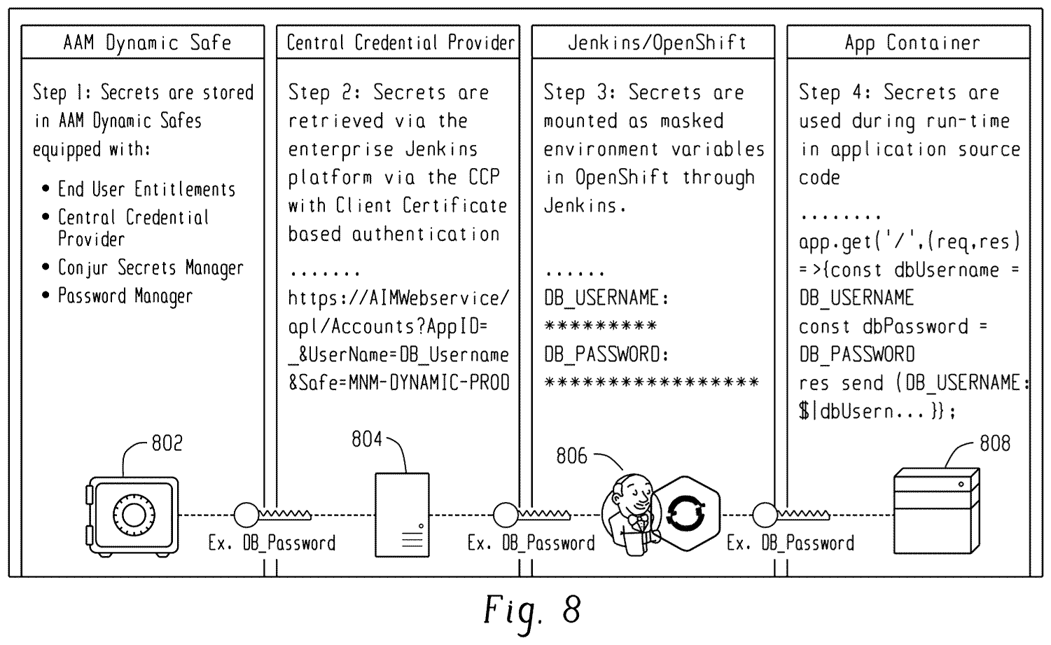

FIG. 8 is a diagram depicting an example of retrieval of secrets from a secrets management system during deployment of a resource. The system provides automated delivery of credential during deployment time which originate from a secure identity repository (e.g., a CyberArk enterprise password vault). Credentials are brokered on behalf of the applications via the enterprise Jenkins/OpenShift integration. At 802, credentials are stored in a dynamic safe that includes end user entitlements, support for central credential provider functionality, a secrets manager and a password manager. At 804, credentials are retrieved via an enterprise Jenkins platform via the central credential provider using client certificate-based authentication. At 806, the credentials are mounted as masked environment variables in OpenShift through Jenkins, and at 808, the credentials are used during runtime in application source code.

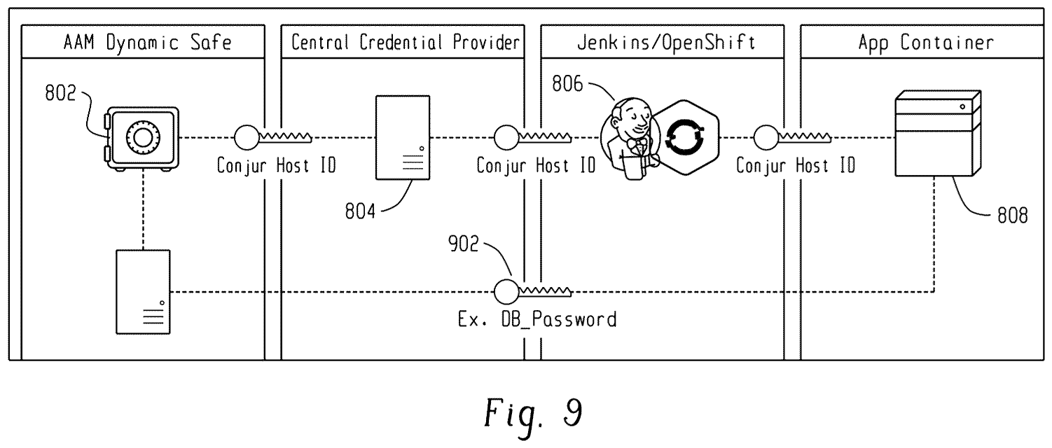

FIG. 9 is a diagram depicting an example of retrieval of secrets from a secrets management system during runtime. Once credentials are retrieved during resource deployment, the secrets management system host ID can be leveraged to obtain credentials during runtime, closing the loop indicated at 902. Subsequent credential needed during runtime can be pulled dynamically from the secure identity repository without the need for hardcoding into software. This arrangement can facilitate and promote credential maintenance (e.g., password rotation), reducing the quantity of secrets stored in the OpenShift system (e.g., only to the secrets management system host ID and API key). The system of FIG. 9 can consolidate credentials to the secure identity repository to promote centralized accounting, reporting, and control enforcement.

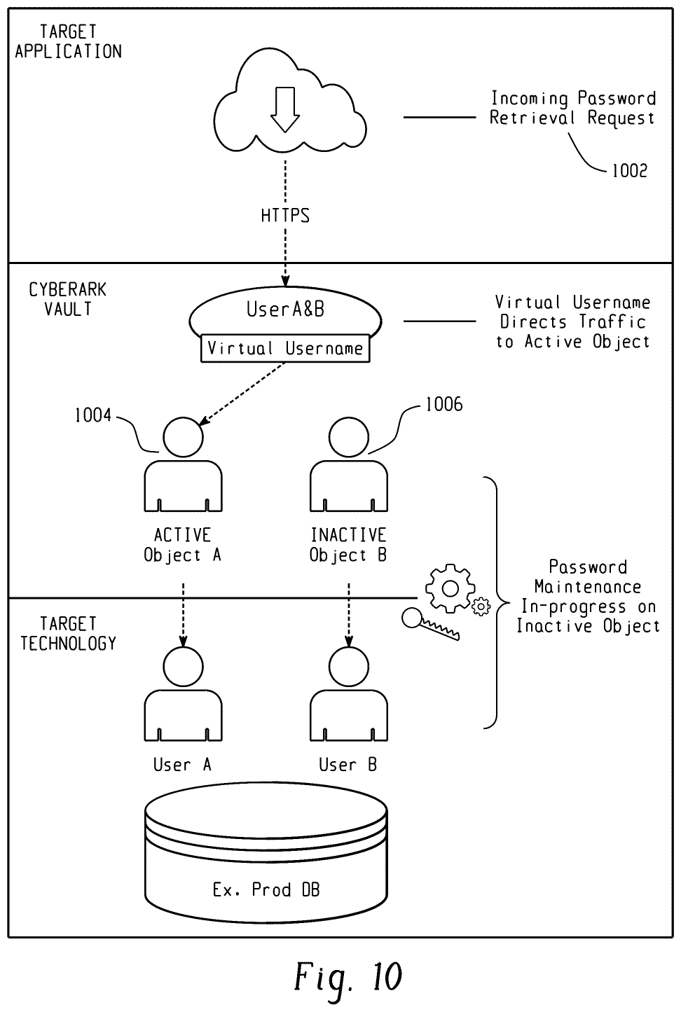

As noted above, for some privileged identities, it may be desirable to maintain secondary credentials to maintain resource accessibility, such as during credential maintenance (e.g., CyberArk rotation of a credential). FIG. 10 is a diagram depicting example maintenance of dual credentials for an identity. At 1002, an incoming password retrieval request for an identity is received at a secure identity repository. The repository by default returns credentials associated with a first sub-identity 1004 that has the desired privileges of the entity. But if that first sub-identity's credentials are currently in maintenance, then the credentials of a second sub-entity 1006 are returned. In the example of FIG. 10, the credentials of sub-identity 1006 are currently in maintenance, such that the credentials of sub-entity 1004 are returned to the request received at 1002. In this way, there is always an active set of credentials, ensuring continuity of operation of the resources.

As discussed above with reference to FIG. 5, in some instances group managed serviced accounts can be utilized, such as for IIS application pools, Windows services, and scheduled tasks. Group managed serviced account can be treated as a different object class in Active Directory, which may restrict password usage to the Windows operating system. In some instances, these identities are out of scope for CyberArk onboarding and do not require additional compensating controls to be compliant with policy requirements. Such instances may benefit from strong passwords (e.g., 240-byte randomly generated passwords) and automatic rotation of passwords every 30 days.

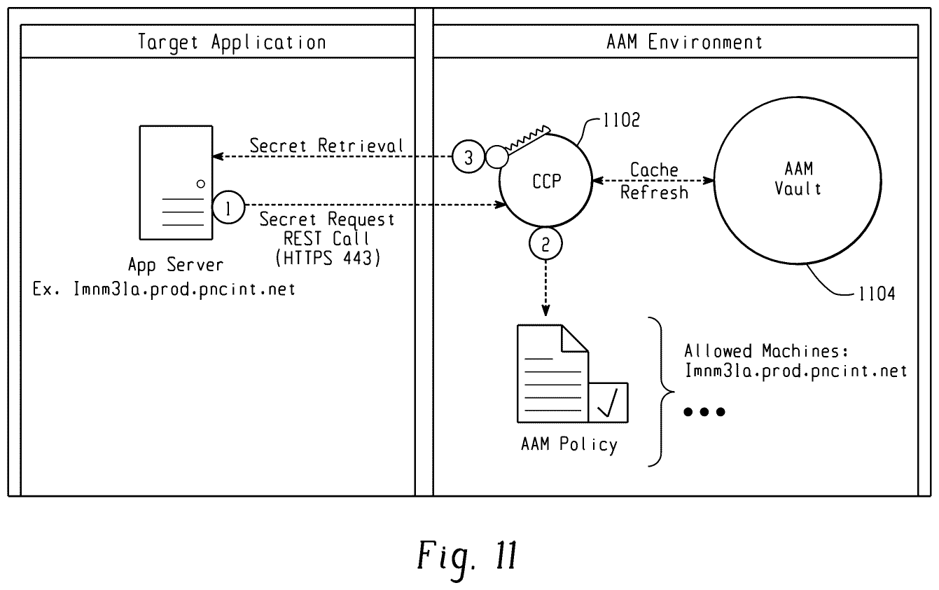

In some instances, credentials may be requested and obtained from a central credential provider. FIG. 11 is a diagram depicting access of credentials from a central credential provider (CCP). The central credential provider may be implemented as an agentless endpoint that enables credential retrieval for applications with static attributes running in persistent server-based environments. In the example of FIG. 11, the central credential provider 1102 confirms that the application details in the secure identification repository 1104 matches characteristics of the requesting application. If the application's characteristics are as expected (e.g., the address of the machine matches), the central credential provider retrieves the requested credentials and returns them to the application.

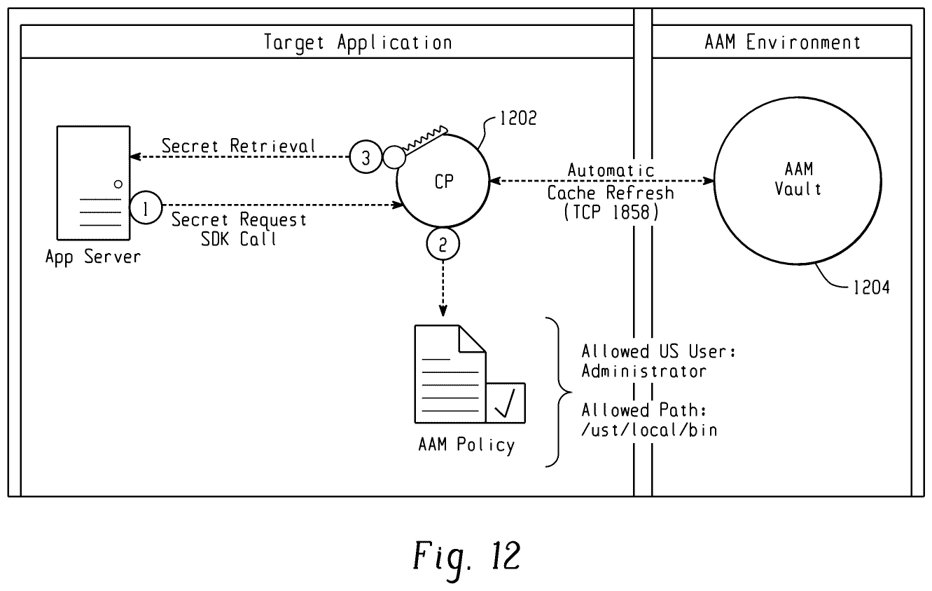

In some instances, a credential provider (CP) may be utilized. FIG. 12 is a diagram depicting access of credentials from a credential provider. The example credential provider 1202 is an agent-based solution installed on the applications underlying operating system layer. The credential provider agent acts as a local encrypted cache that synchronizes with the enterprise secure identity repository 1204 on a scheduled basis. This arrangement can promote system resiliency, such as in the event of a network outage where communication with the secure identity repository 1204 is impacted. In that instance, the running application would still have access to all secrets stored in the local cache. Such an arrangement can provide increased security controls for authentication, such as restricting access to a specific program hash or path.

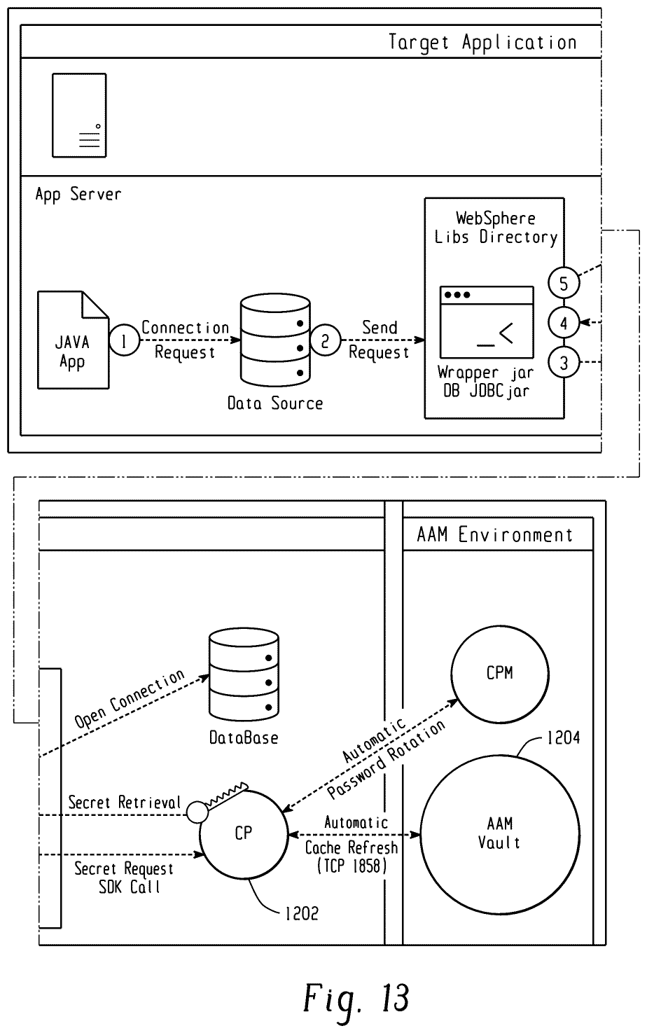

In some examples, an application sever credential provider (ASCP) may be implemented. FIG. 13 is a diagram depicting deployment of an application server credential provider. An example application server credential provider brokers JDBC connections, which can eliminate hard coding of database credentials for middleware devices, such as IBM WebSphere, Oracle WebLogic, JBoss, and Apache Tomcat. Leveraging features of the credential provider 1202 interacting with a security identity repository 1204 described with respect to FIG. 12, an example application server credential provider integrates with application servers, potentially without any code changes. A configuration change can be made to request credentials on behalf of new or existing data sources.

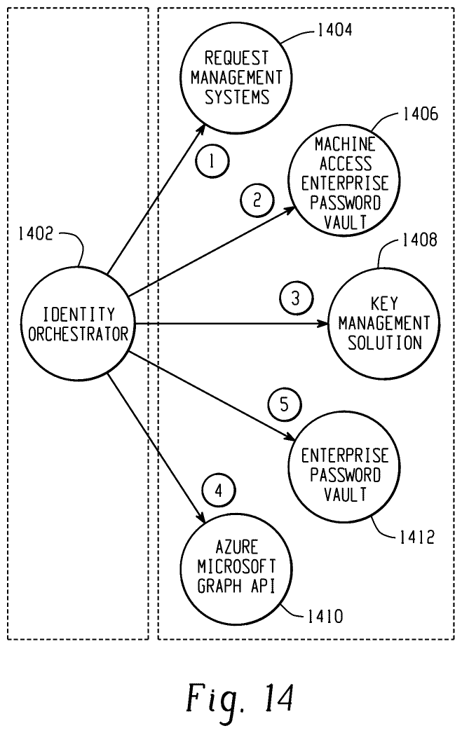

Systems and methods as described herein may be implemented in a wide variety of use cases. FIG. 14 is a diagram depicting an identity orchestrator providing streamlined provisioning of an application registration based on a request. At 1404, the identity orchestrator 1402 receives an application request from an entity, such as a resource/request management platform (e.g., ServiceNow or Jira). The orchestrator 1402 retrieves run-time secrets (credentials) from a machine access enterprise password vault (e.g., a CyberArk AAM or Conjur database) at 1406 to execute subsequent actions using an enterprise password vault (e.g., CyberArk), a key management solution (e.g., Venafi), and Azure. At 1408, the orchestrator 1402 authenticates to the key management solution and generates a certificate signing request, receiving the client certificate in reply. At 1410, the orchestrator authenticates to Microsoft Graph API and creates an application registration, sets the client certificate from the key management solution, and generates a client secret. At 1412, the orchestrator 1402 authenticates to an enterprise password valut and stores the Azure app registration client secret in the enterprise password vault.

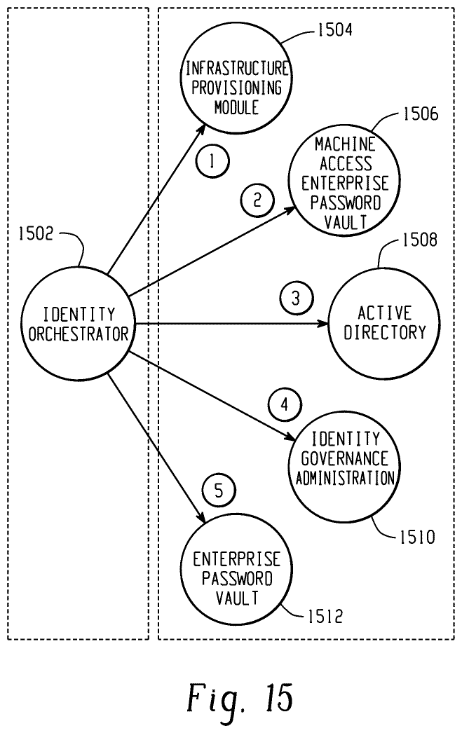

FIG. 15 is a diagram depicting an identity orchestrator providing standardized privileged access patterns into a server build workflow. At 1504, the orchestrator begins the process based on a notice of server provisioning from an infrastructure provisioning module. At 1506, the orchestrator retrieves run-time secrets from a machine access enterprise password vault (e.g., a CyberArk AAM or Conjur database) to use in subsequent actions. In Active Directory, the orchestrator 1502 creates standardized access groups and non-human accounts at 1508. At 1510, entitlements are rendered in an identity governance administration (IGA) solutions catalogue for newly created AD groups. At 1512, enterprise password valuts (e.g., CyberArk) safes are created, AD groups are added as safe members, and privileged accounts are stored.

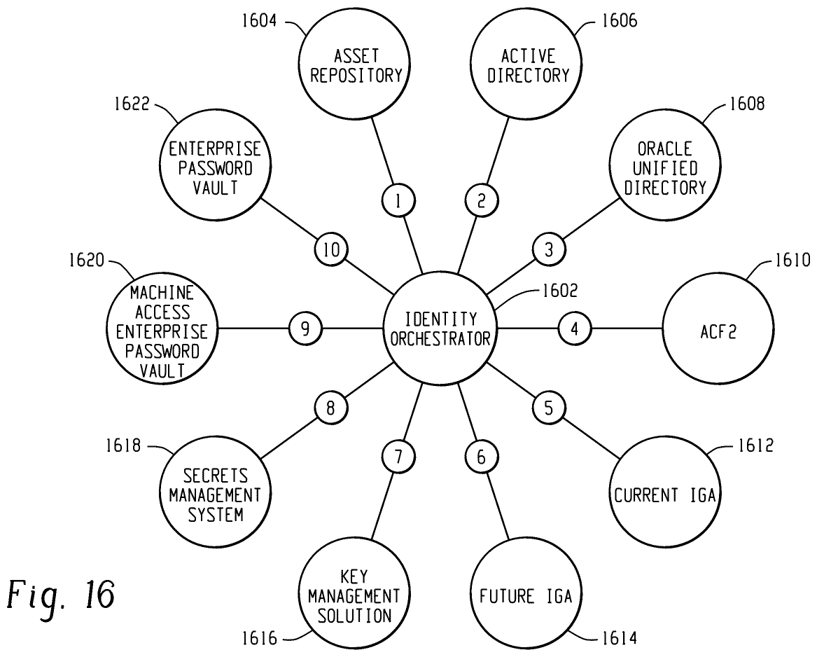

FIG. 16 is a diagram depicting an identity orchestrator operating as an automated reconciliation tool for synchronizing data between systems. At 1604, the identity orchestrator 1602 queries the asset repository to identify applications marked as retired. At 1606, 1608, 1610, the identity orchestrator 1602 checks for orphaned groups and identities in Active Directory, Oracle Unified Directory, and ACF2. At 1612, 1614, the identity orchestrator 1602 queries Current IGA (e.g., OIM) and Future IGA to identify and remediate obsolete entitlement data. At 1616, the identity orchestrator 1602 performs certificate and key revocation via Venifi. Then at 1618, the orchestrator removes secrets management system (e.g., Conjur) policy and app IDs associated with the application marked as retired. At 1620, 1622, the identity orchestrator 1602 updates the machine enterprise password (e.g., CyberArk) safes, password objects, AAM configurations and other metadata based on the application retirement.

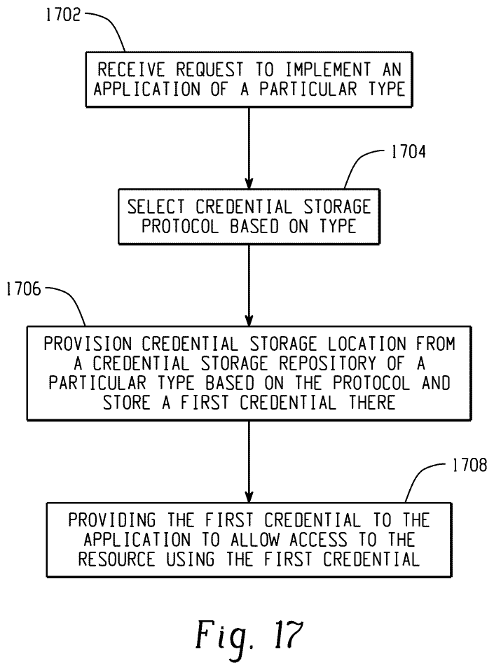

FIG. 17 is a flow diagram depicting a method of enforcing compliance with security controls. At 1702, a request is received to implement an application that is associated with resources to be protected by credentials. A type associated with application is determined. At 1704, a credential storage protocol is selected based on the determined type. A credential storage location is provisioned from a first of a plurality of types of credential storage repositories of different types at 1706 based on the determined protocol. A first credential is stored in the provisioned storage location, and the first credential is provided to the application at 1708 to enable the application to access the resources protected by the credentials.

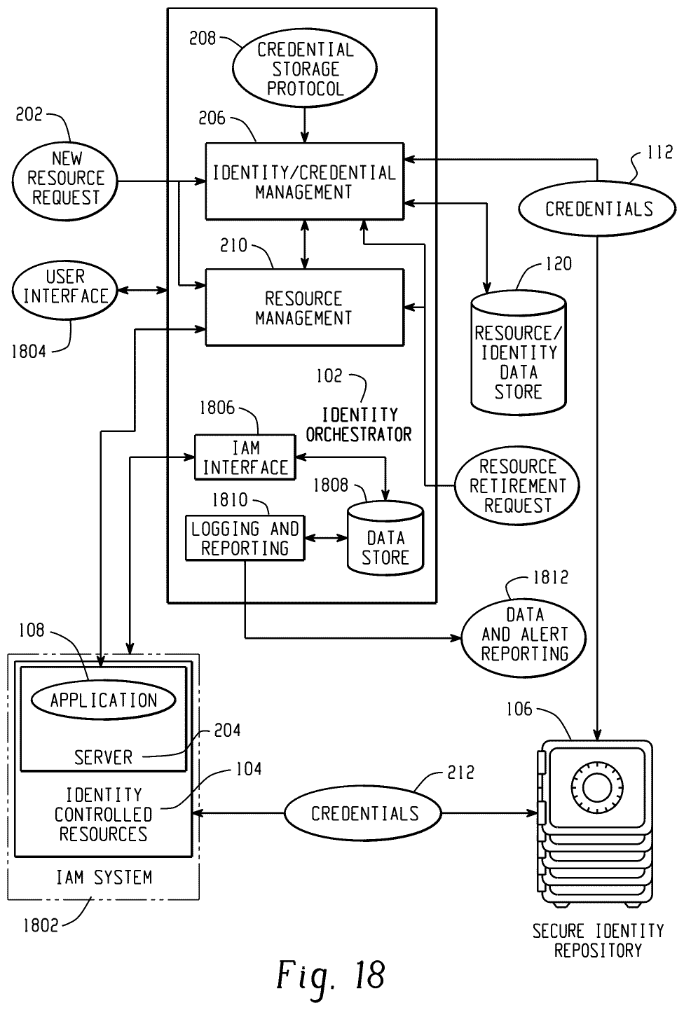

An identity orchestrator may be implemented in a variety of different operational environments. FIG. 18 is a diagram depicting an example implementation of an identity orchestrator operating in an environment where it provides centralized interaction with one or more identity access management systems. The identity orchestrator 102 of FIG. 18 may be configured to provide centralized policy aggregation across multiple identity and access management (IAM) systems to enable unified policy management, certification, and governance. The identity orchestrator 102 is configured to collect and consolidate policy-based access controls from various IAM tools. In embodiments, the identity orchestrator, directly or indirectly, provides a user interface 1804 that presents an integrated administrative pane for policy monitoring, compliance certification, and governance across an IAM environment.

In certain examples, the identity orchestrator 102 is implemented so as to unify policy-based access controls from diverse IAM systems, offering a consolidated interface that enables seamless policy governance and certification. An example identity orchestrator 102 is able to ingest, analyze, and enforce policies across multiple IAM environments within an organization, regardless of the source IAM tool. FIG. 18 depicts an example IAM interface 1806 that interacts with IAM system 1802. IAM system 1802 is configured to manage access to one or more identity controlled resources 104, such as an application 108 that is operating on a server 204. In embodiments, the identity orchestrator 102 is configured to interact with and manage operations of multiple such IAM systems 1802, which may be of disparate types. Those interactions may be via a single IAM interface 1806 that is able to communicate with IAM systems 1802 of different types, or multiple individual IAM interfaces 1806 that are particularly configured for interacting with different ones or types of IAM systems 1802 may be implemented by an identity orchestrator 102.

The identity orchestrator 102 of FIG. 18 may be configured to provide a variety of functionality. As noted above, the identity orchestrator 102 provides data aggregation and ingestion functionality associated with the one or more IAM systems 1802 with which it interacts. For example, the identity orchestrator 102 may be configured to connect to and retrieve policy data from a wide array of IAM systems 1802, including data related to privileged access management (PAM), single sign-on (SSO), multi-factor authentication (MFA), and identity governance and administration (IGA) tools. In examples, an IAM interface 1806 is configured to establish API or LDAP-based connectors with each supported IAM system 1802 to pull policy-based access controls for storage in a data store 1808. The identity orchestrator 102 may be configured to utilize data normalization to standardize the diverse policies from different IAM tools into a unified format and to store policy data in a centralized, scalable database 1808 that may support high-performance query-based retrieval.

The identity orchestrator 102 may further be configured to provide a centralized policy management interface, such as via user interface 1804. In an embodiment, the identity orchestrator provides a comprehensive, single-pane interface for policy administration, allowing administrators to view, edit, and certify policies across multiple IAM systems 1802 from a centralized location at the user interface 1804. An identity orchestrator 1802 may include a user-friendly graphical interface that displays policies by category, risk level, and IAM source. The user interface 1804 may enable administrator to apply bulk changes across policies or make granular modifications as required. Some implementations may provide policy mapping features that link policies from different IAM systems 1802, highlighting policy overlaps, conflicts, or gaps.

An identity orchestrator 102 may provide data collection, aggregation, and analysis that enables policy certification and compliance automation. In one example, an identity orchestrator 102 includes tools for automated policy certification, compliance tracking, and reporting to support audit and regulatory requirements. For example, an identity orchestrator may be configured to implement periodic certification workflows that automatically prompt policy review and approval based on regulatory and organizational requirements. Data may be tracked via data store 1808 and analyzed at 1810 to generate compliance reports 1812 that track policy adherence across IAM environments, identifying any deviations or expired certifications. An identity orchestrator 102 may further integrate with security and compliance tools to streamline certification and reporting processes, allowing for automated notifications at 1812 to relevant teams in case of non-compliance.

In some examples, an identity orchestrator 102 may be provisioned to include policy conflict detection and resolution capability. A system 102 may be configured to identify and resolve conflicts between policies aggregated from various IAM systems 1802, ensuring consistency and alignment with organizational standards. In embodiments, an identity orchestrator 102 may include algorithms that detect conflicting or redundant policies between systems, such as conflicting access permissions or privilege levels. Such a system may provide suggestions for conflict resolution based on predefined policies and organizational standards. An identity orchestrator 102 may enable policy administrators to customize conflict resolution parameters and establish automatic or manual resolution protocols.

An identity orchestrator 102 may further be implemented to provide automated policy recommendations and risk scoring. In such an implementation, an identity orchestrator 102 analyzes aggregated policies to provide risk scores and recommend policy modifications for enhanced security. In one example, a system utilizes machine learning to score policies based on their risk level, factoring in user roles, access privileges, and recent security incidents. A system may generate recommendations for policy adjustments or enhancements based on historical compliance data, user access patterns, and organizational policies. A system may further prioritize policy modification suggestions based on risk scores, enabling administrators to focus on high-risk areas first.

As noted above, an identity orchestrator may utilize one or more IAM interfaces 1806 or other tools to provide integration with existing IAM and security tools. Such a system may facilitate integration with IAM and security platforms to ensure data consistency and enhance existing security capabilities. In certain examples, an identity orchestrator 102 may support bi-directional synchronization with IAM tools to ensure that policy updates within the aggregator are reflected across all connected IAM systems. A system may enable integrations with existing SIEM, DLP, and incident response tools for real-time policy enforcement and threat monitoring. An identity orchestrator may further provide APIs (e.g., via IAM interfaces 1806) for integration with additional security and governance applications, allowing for expanded functionality and adaptability to evolving security landscapes.

An identity orchestrator 102 may further be implemented so as to provide monitoring and alerts, including real-time monitoring and alerts. A system may be configured to provide monitoring of policy adherence and generate alerts for policy violations or high-risk modifications. In one implementation, an identity orchestrator 102 monitors policy status across IAM systems in real-time, with configurable alerts for policy changes or violations. That identity orchestrator 102 allow customizations of alert thresholds and notification preferences, enabling administrators to focus on high-priority events. The system may include logging and auditing features 1810 to maintain a record of policy changes, access events, and system interactions for compliance and troubleshooting purposes.

An identity orchestrator 102 may further be configured to provide desirable security and data privacy effects. For example, a system may be setup to ensure secure handling of policy data throughout the aggregation, storage, and management processes. In one example, a system is configured to encrypt data at rest and in transit, utilizing robust encryption standards to protect policy information. That system may further implement role-based access controls (RBAC) within the aggregator, ensuring only authorized users can view or modify policy data. A system may also conduct periodic security assessments of the system to detect and mitigate potential vulnerabilities.

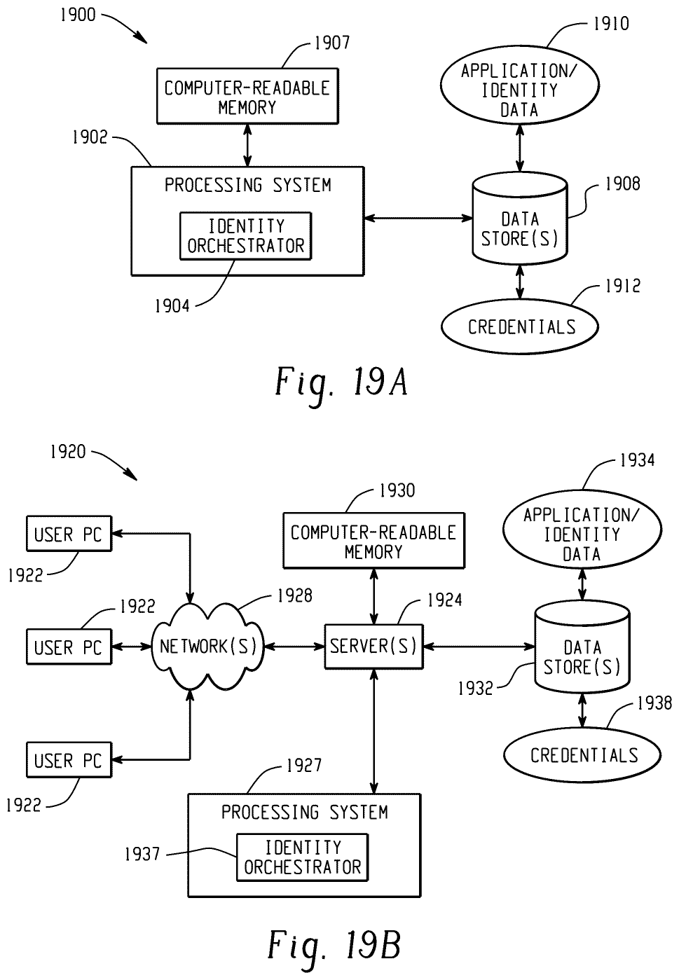

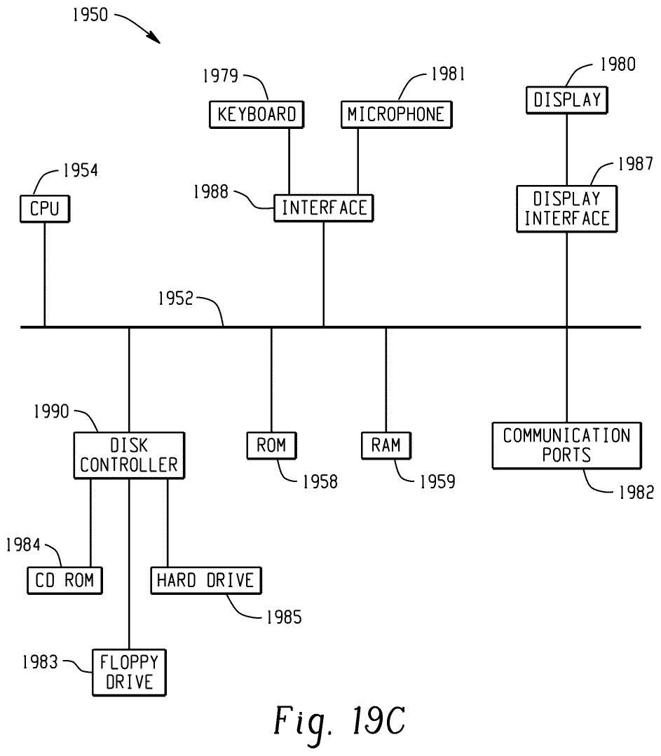

FIGS. 19A, 19B, and 19C depict example systems for implementing the approaches described herein for implementing an identity orchestrator. For example, FIG. 19A depicts an exemplary system 1900 that includes a standalone computer architecture where a processing system 1902 (e.g., one or more computer processors located in a given computer or in multiple computers that may be separate and distinct from one another) includes a computer-implemented identity orchestrator 1904 being executed on the processing system 1902. The processing system 1902 has access to a computer-readable memory 1907 in addition to one or more data stores 1908. The one or more data stores 1908 may include application/identity data 1910 as well as credentials 1912. The processing system 1902 may be a distributed parallel computing environment, which may be used to manage very large-scale data sets.

FIG. 19B depicts a system 1920 that includes a client-server architecture. One or more user PCs 1922 access one or more servers 1924 that include identity orchestrator 1937 operating on a processing system 1927 via one or more networks 1928. The one or more servers 1924 may access a computer-readable memory 1930 as well as one or more data stores 1932. The one or more data stores 1932 may include application/identity data 1934 as well credentials 1938.

FIG. 19C shows a block diagram of exemplary hardware for a standalone computer architecture 1950, such as the architecture depicted in FIG. 19A that may be used to include and/or implement the program instructions of system embodiments of the present disclosure. A bus 1952 may serve as the information highway interconnecting the other illustrated components of the hardware. A processing system 1954 labeled CPU (central processing unit) (e.g., one or more computer processors at a given computer or at multiple computers), may perform calculations and logic operations required to execute a program. A non-transitory processor-readable storage medium, such as read only memory (ROM) 1958 and random access memory (RAM) 1959, may be in communication with the processing system 1954 and may include one or more programming instructions for enforcing compliance with security protocols. Optionally, program instructions may be stored on a non-transitory computer-readable storage medium such as a magnetic disk, optical disk, recordable memory device, flash memory, or other physical storage medium.

In FIGS. 19A, 19B, and 19C, computer readable memories 1907, 1930, 1958, 1959 or data stores 1908, 1932, 1983, 1984, 1988 may include one or more data structures for storing and associating various data used in the example systems. For example, a data structure stored in any of the locations may be used to store data from XML files, initial parameters, and/or data for other variables described herein. A disk controller 1990 interfaces one or more optional disk drives to the system bus 1952. These disk drives may be external or internal floppy disk drives such as 1983, external or internal CD-ROM, CD-R, CD-RW or DVD drives such as 1984, or external or internal hard drives 1985. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1990, the ROM 1958 and/or the RAM 1959. The processor 1954 may access one or more components as required.

A display interface 1987 may permit information from the bus 1952 to be displayed on a display 1980 in audio, graphic, or alphanumeric format. Communication with external devices may optionally occur using various communication ports 1982.

In addition to these computer-type components, the hardware may also include data input devices, such as a keyboard 1979, or other input device 1981, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to conduct the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A computer-implemented method of enforcing compliance with security controls, comprising:
receiving a request to implement an application that is associated with resources to be protected by credentials;
determining a type associated with application;
selecting a credential storage protocol based on the determined type;
provisioning a credential storage location from a first of a plurality of types of credential storage repositories of different types based on the determined protocol;
storing a first credential in the provisioned storage location; and
providing the first credential to the application to enable the application to access the resources protected by the credentials.

2. The method of claim 1, wherein the first type of credential storage repository requires maintenance of the first credential at the expiration of a first period of time.

3. The method of claim 2, wherein a second type of credential storage repository requires maintenance of credentials at the expiration of a second period of time that differs from the first period of time.

4. The method of claim 2, further comprising:
determining that the first credential is associated with privileged access;
storing a second credential in the provisioned storage location based on the first credential associated with privileged access, wherein the second credential is associated with a second expiration period that differs from the first period of time associated with the first credential.

5. The method of claim 4, wherein the second credential provides access to the resources during maintenance of the first credential.

6. The method of claim 4, wherein the second credential is required to complete maintenance of the first credential.

7. The method of claim 1, wherein the credential storage location receives a request for the first credential that includes a plurality of characteristics associated with the application;
wherein the credential storage location provides the first credential to the application based on the plurality of characteristics meeting predetermined criteria.

8. The method of claim 7, wherein the predetermined criteria include an address associated with the application.

9. The method of claim 1, wherein the first credential is provided to the application by a credential provider that comprises an encrypted cache of credentials that periodically synchronizes with the credential storage location.

10. The method of claim 1, wherein the request to implement the application is associated with a graphical user interface that enables selection of one of a plurality of applications of different types to implement.

11. The method of claim 1, further comprising:
receiving a request to implement a second application that is associated with second resources;
determining a type associated with the second application, wherein the second application is determined to be of a different type than the application;
selecting a second credential storage protocol based on the determined type associated with the second application;
provisioning a second credential storage location;
storing a second credential in the provisioned second credential location;
providing the second credential to the second application to enable the second application to access the second resources.

12. The method of claim 1, further comprising:
accessing an identity data store to determine an identity having privileges for accessing the resources protected by credentials;
wherein the first credential is associated with the identity.

13. The method of claim 12, further comprising:
receiving an indication that the application is to be retired;
determining a credential associated with the application;
determining an identity associated with the application;
retiring the credential associated with the application;
determining whether the identity associated with the application should be retired, wherein the identity is retired upon determining that the identity should be retired.

14. The method of claim 13, wherein the identity is determined to be retired when:
the identity is associated with the application to be retired; or
the identity does not have permission to access any applications other than the application to be retired.

15. The method of claim 13, wherein the identity is determined based on the credential associated with the application.

16. The method of claim 1, further comprising:
maintaining a database indicating identities associated with a plurality of applications;
periodically querying the database to determine whether any identities are associated only with retired applications such that those orphaned identities should be retired.

17. The method of claim 1, further comprising:
providing a second credential to the application based on the application's possession of the first credential.

18. A computer-implemented system for enforcing compliance with security controls, comprising:
a resource management platform configured to provide a graphical user interface for receiving a request to implement an application that is associated with resources to be protected by credentials;
an identity orchestration module configured to:
determine a type associated with application; and
select a credential storage protocol based on the determined type;
a plurality of credential storage repositories of different types;
wherein the identity orchestration module is configured to provision a credential storage location from a first credential storage repository based on the determined protocol and store a first credential in the provisioned storage location;
wherein the system is configured to provide the first credential to the application to enable the application to access the resources protected by the credentials.

19. The system of claim 1, further comprising;
an application-identity data store containing data associated with one or more identities associated with the application.

20. The system of claim 19, wherein, upon receiving an indication that the application is to be retired, the identity orchestration module is configured to:
determine a credential associated with the application;
determine an identity associated with the application;
retire the credential associated with the application;
determine whether the identity associated with the application should be retired, wherein the identity is retired upon determining that the identity should be retired.

21. A computer-implemented system of enforcing compliance with security controls, comprising:
means for determining a credential storage protocol based on an application type associated with a request to implement an application that is associated with resources to be protected by credentials;
means for provisioning a credential storage location from a first of a plurality of types of credential storage repositories of different types based on the determined protocol;
means for providing a first credential to the application from the provisioned storage location to enable the application to access the resources protected by the credentials.
